(19) United States
(12) Patent Application Publication
(10) Pub. No.: US 2015/0229228 A1
(43) Pub. Date: Aug. 13, 2015

(54) USB POWER CONVERSION DEVICE

(71) Applicant: GlobTek, Inc., Northvale, NJ (US)

(72) Inventor: David Michael Rakovsky, Cresskill, NJ (US)

(73) Assignee: GlobTek, Inc., Northvale, NJ (US)

(21) Appl. No.: 14/176,476

(22) Filed: Feb. 10, 2014

(51) Int. Cl. H02M 7/00

(52) U.S. Cl. CPC H02M 7/003

(57) ABSTRACT

A device can be used to convert power supplied by an external power source into power that is compatible with an external electronic device. In an example implementation, the device receives direct current (DC) power from the external power source through a USB connection interface, converts it into DC power of a different voltage, and outputs the converted power to the external electronic device.

### TECHNICAL FIELD

This disclosure relates to electrical power converters, and more particularly to devices that convert electrical power supplied by a Universal Serial Bus (USB) port.

### BACKGROUND

Electronic devices require electrical power to function, and commonly require input power with specific voltage and current characteristics. In order to supply electronic devices with suitable input power, power converters can be used to convert power received from a readily accessible source (e.g., power provided by an electrical outlet or port, a battery, or other source) into power that is compatible with the device. Once converted, this power can be used to power the device and/or recharge the device's internal power store (e.g., a battery or other power cell).

Universal Serial Bus (USB) is an industry standard that defines the cables, connectors, and communications protocols used in a bus for connection, communication, and power supply between computers and other electronic devices. Among other specifications, USB defines standard voltage and current characteristics for power carried a USB bus. For example, USB 1.0 specifies that a USB bus can deliver power at a voltage of 5V direct current (DC) with a maximum current of 150 mA (0.75 W), USB 2.0 specifies that a USB bus can deliver power at a voltage of 5V DC with a maximum current of 500 mA (2.5 W), and USB 3.0 specifies that a USB bus can deliver power at a voltage of 5V DC with a maximum current of 900 mA (4.5 W). Through the use of standardized connection ports and cables, power can be transferred between devices via a USB bus.

### SUMMARY

Various aspects of the invention are set forth in the claims.

In general, in one aspect, an apparatus for providing electrical power to an electronic device includes an input interface comprising a Universal Serial Bus (USB) connector, an output interface that includes an output connector, and a conversion module. The input interface is arranged to couple to an external power source through the USB connector, and transmit electrical power at a first voltage from the external power source to the conversion module. The conversion module is arranged to convert electrical power at the first voltage into electric power at a second voltage. The output interface is arranged to couple to the electronic device through the output connector, and transmit electrical power at the second voltage from the conversion module to the electronic device.

In general, in another aspect, a system includes an electronic device, an external power source, and a Universal Serial Bus (USB)-based cable. The USB-based cable includes an input interface that includes a USB connector coupled to the external power source through the USB connector, an output interface that includes an output connector, and a conversion module. The input interface is arranged to transmit electrical power at a first voltage from the external power source to the conversion module. The conversion module is arranged to convert electrical power at the first voltage into electric power at a second voltage. The output interface is arranged to couple to the electronic device through the output connector and transmit electrical power at the second voltage from the conversion module to the electronic device.

Implementations of these aspects may include one or more of the following features.

For example, the electrical power at the first voltage and the electrical power at the second voltage can be direct current (DC)-based. The electronic device can further include a battery, and the conversion module can include a regulation module to regulate the transmission of electrical power to the electronic device based on a charge state of the battery. In some implementations, electrical power can be transmitted to the electronic device at a first rate when the battery is in an uncharged or partially charged state. Electrical power can be transmitted to the electronic device at a second rate when the battery is in a substantially fully charged state, where the second rate is less than the first rate. The USB connector can include, for example, a male USB plug. The input interface can further include an electrically conductive cable that couples the USB connector to the conversion module. In some cases, the cable can be coupled to the conversion module through a detachable interface. The first voltage can be less than the second voltage. The electronic device can include, for example, at least one member from the following group: a computing device, a telephone, and a battery.

Other aspects, features and advantages will be apparent from the following detailed description, the accompanying drawings, and the claims.

### BRIEF DESCRIPTION OF THE DRAWINGS

FIG. 1 shows an example device to convert power.

FIG. 2 is a schematic of an example conversion module.

FIG. 3 is a schematic of another example conversion module.

FIGS. 4-12 show other example devices to convert power.

### DETAILED DESCRIPTION

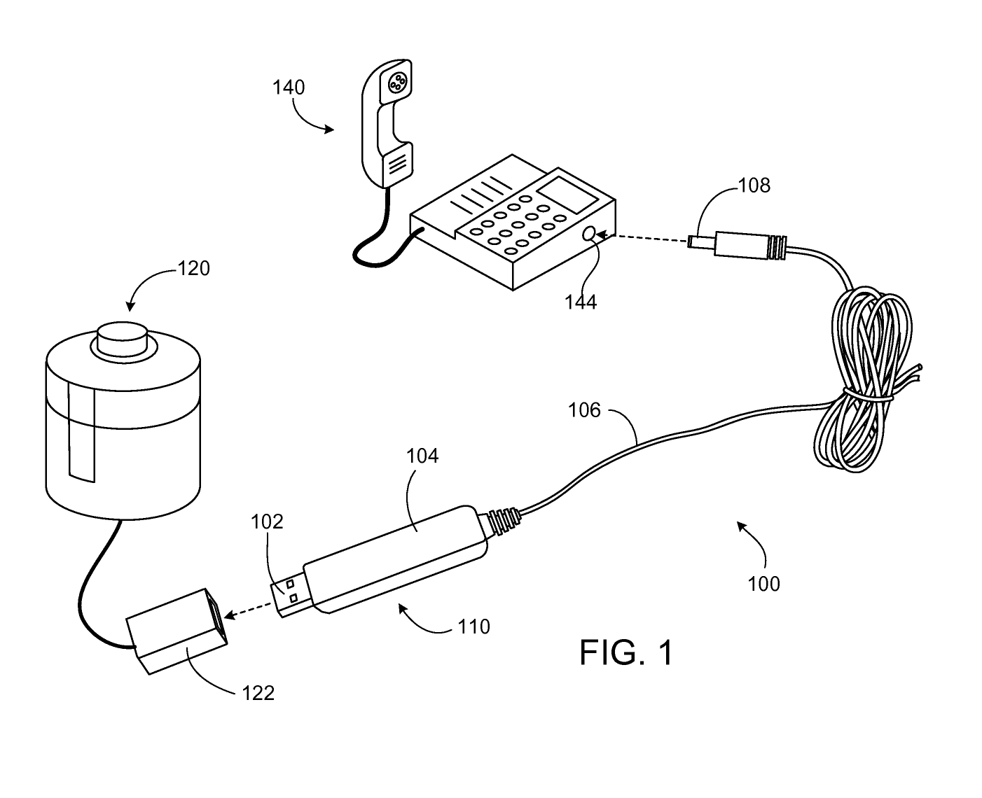

As shown in FIG. 1, an example device 100 can be used to convert power supplied by an external power source 120 into power that is compatible with an external electronic device 140. In an example implementation, device 100 receives direct current (DC) power from the external power source 120 through a USB connection interface, converts it into DC power of a different voltage, and outputs the converted power to the external electronic device 140.

Device 100 includes an input connection interface 102, a conversion module 104, a connector cable 106, an output connection interface 108, and a housing 110.

Input connection interface 102 and conversion module 104 can be co-mounted within the housing 110. Input connection interface 102 allows device 100 to couple to external power source 120 such that power can be transferred from the external power source 120 to the device 100. In this example, input connection interface 102 is a USB connector (i.e., a Standard-A plug) that can couple to a corresponding USB receptacle 122 (i.e., a Standard-A receptacle) of external power source 120.

Conversion module 104 converts the power received from the external power source 120 into power that is compatible with external device 140. In this example, conversion module 104 receives direct current (DC) power at 5V DC, and converts the DC power to a different voltage (e.g., 1V DC, 10V DC, 15V DC, 20V DC, or 55 V DC), which, depending on the implementation, may be higher or lower than the voltage of external power source 120.

Connector cable 106 carries current between components of device 100. In this example, connector cable 106 carries current from conversion module 104 to the output connection interface 108. Connector cable 106 can include, for example, a conductive wire made of an electrically conductive material (e.g., copper, aluminum, or other conductive material) to carry current, and can be coated with an electrically insulating material (e.g., rubber, polyvinyl chloride, or other insulating material) to shield the user from electrical discharge and to protect the conductive wire from physical damage. Connector cable 106 can be of varying lengths (e.g., 1 inch, 6 inches, 1 foot, 3 feet, 6 feet, or 10 feet), depending on the implementation.

Output connection interface 108 allows device 100 to couple to the external electronic device 140, such that converted power can be transferred from the device 100 to the external electronic device 140. In this example, output connection interface 108 is a power connector that can couple to a corresponding connection receptacle 142 of external electronic device 140.

Although in this example input connection interface 102 is a Standard-A USB plug, input connection interface 102 can be any USB connector suitable to interface with receptacle 122. For example, in some implementations, input connection interface 102 and receptacle 122 are a USB Standard-B plug and receptacle, respectively. In other implementations, input connection interface 102 and receptacle 122 are a Mini-B USB plug and receptacle, respectively. In other implementations, input connection interface 102 and receptacle 122 are a Micro-B USB plug and receptacle, respectively. In this manner, input connection interface 102 can be any USB connector appropriate for the desired application.

In a similar manner, output connection interface 108 can be any connector suitable to interface with receptacle 144. For example, output connection interface 108 can be a standardized connector, or it can be a connector that is specific to a particular device or device manufacturer.

External power source 120 can be any device or system that can provide power through receptacle 122. For example, in some implementations, external power source 120 is a device or system that generates power (e.g., an electric generator or power plant) and delivers the power, either directly or indirectly (e.g., through an electrical grid), to receptacle 122. In some implementations, external power source 120 does not directly generate power, but receives power from another device or system, and delivers all or part of its received power to receptacle 122. As an example, external power source 120 can be a computer that receives power from an electric generator, and provides a portion of its received power through receptacle 122. In some implementations, external power source 120 stores electric power. For example, external power source 120 can be a battery or other similar device that stores electrical power and outputs this power through receptacle 122. Receptacle 122 can be physically attached directly to external power source 120, or it can be physically remote (e.g., a wall outlet or other remotely wired connector).

External electronic device 140 can be any device that uses electric power to function. For instance, in some implementations, external electronic device 140 can be a computing device (e.g., a computer, tablet, smartphone, or personal digital assistant (PDA)). In some implementations, external electronic device 140 is a communications device (e.g., a cellular phone, a telephone, or a video phone). In some implementations, external electronic device 140 is an appliance (e.g., a light, an office appliance, a kitchen appliance, or a bathroom appliance). In some implementations, external electronic device 140 is an electric tool (e.g., an electric drill or an electric pump). These examples are non-limiting, and external electronic device 140 can include any device that requires electric power.

The power requirements of external electronic device 140 can vary depending on the implementation. For example, in some implementations, external electronic device 140 requires input power of a specific voltage (e.g., 1V DC, 5V DC, 10V DC, 15V DC, or 55V DC), a specific range of voltages (e.g., 1-5V DC, 10-15V DC, or 20-55V DC), a specific current (e.g., 100 mA, 500 mA, 1 A, or 2 A), and/or a specific range of currents (e.g., 100-500 mA or 1 A-2 A).

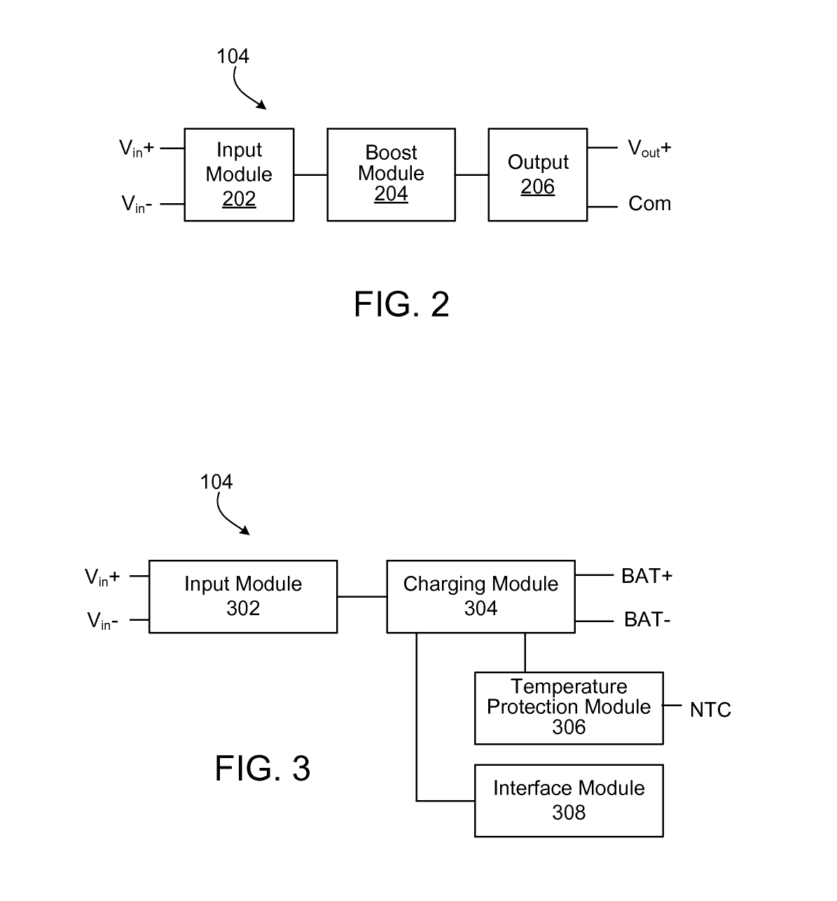

Conversion module 104 can be any component or set of components that converts power from an input voltage and current to an output voltage and current. An example implementation of conversion module 104 is shown in FIG. 2. In this example, conversion module 104 includes an input module 202, a boost module 204, and an output module 206.

Input module 202 filters and/or regulates the electric input into conversion module 104 in order to protect convert module 104 from damage due to input power with undesirable characteristics. For example, input module 202 can filter EMI or other noise from the input power (i.e., the electrical power input into positive polarity input pin Vᵢₙ+ and negative polarity input pin Vᵢₙ−) through an appropriate line filter module. This line filter module can attenuate or eliminate EMI from the input power before it is carried to other components of conversion module 104. In another example, module 202 can include a line protection module that restricts the passage of power that that has too high a voltage (e.g., voltage that is higher than a pre-determined operational or safe range) and/or too high a current (e.g., current that is higher than a pre-determined operational or safe range). In this manner, module 202 ensures that the power input into conversion module 104 has acceptable characteristics.

Boost module 204 converts the filtered power from the input voltage and current to the output voltage and current. In this example, boost module 204 is a synchronous boost module (i.e., a voltage converter with an internal transistor switch and a transistor synchronous rectifier) that “steps up” an input voltage to a higher output voltage. For example, module 204 can step up an input voltage of 5V to an output voltage of 9V. This also can alter the current of the input power. For example, in boosting the input voltage from 5V to an output voltage of 9V, the current may be reduced from an input current of 4 A to 1.7 A. Thus, boost module 204 converts the input power from an input voltage and current to a desired output voltage and current.

Output module 206 regulates the power output from converter module 104 in order to protect the external electronic device 140 from damage due to output power with undesirable characteristics. For example, in some implementations, boost module 204 may introduce noise into the converted power. Output module 206 can include an appropriate line filter module, such that noise in the output power (i.e., the electrical power output from positive polarity output pin Vin+ and common ground pin Com) is attenuated or eliminated. In another example, output module 206 can include a line protection module that restricts the passage of power that that has too high a voltage (e.g., voltage that is higher than a pre-determined operational or safe range) and/or too high a current (e.g., current that is higher than a pre-determined operational or safe range). In this manner, module 202 ensures that the power that is passed into external electronic device 140 has acceptable characteristics.

The above arrangement of conversion module 104 is provided merely as an example. Accordingly, conversion module 104 can include other arrangements and combinations of components. For example, in some implementations, instead of a synchronous boost module, boost module 204 can be a different type of voltage converter, such as a buck, buck-boost, boost-buck, flyback, or forward voltage converter. As another example, in some implementations, conversion module 104 has a voltage step-down module (e.g., a module having a buck voltage conversion topology) instead of boost module 204, and conversion module 104 can be used to step down an input voltage to a lower output voltage. In addition, the power that is input into boost module 204 need not equal the power that is output from boost module 204. As an example, boost module 204 may convert input power having a voltage of 5V DC and a current of 4 A (20 W) to output power having a voltage of 9V DC and a current of 1 A (9 W). As another example, boost module 204 may convert input power having a voltage of 5V DC and a current of 1 A (5 W) to output power having a voltage of 3.7V DC and a current of 1 A (3.7 W). Conversion module 104 also can include fewer, additional, or different input protection components within input module 202, such that input module 202 provides less, additional, or different input protection functionality. Likewise, conversion module 104 can include fewer or additional output protection components within output module 206, such that output module 206 provides less, additional, or different output protection functionality.

In some implementations, external electronic device 140 is, or includes, a rechargeable battery. Example rechargeable batteries include lithium-ion (Li-ion), lithium-polymer (Li-poly), nickel metal hydride (NiMH), and nickel cadmium (NiCd) batteries. In order to ensure that a rechargeable battery is recharged safely and effectively, the power that is input into the battery may need to be regulated, such that the correct amount of power is applied. Too much power could, for example, cause the battery to overheat and/or rupture, causing damage to the battery and any surrounding devices. Too little power could cause the battery to recharge more slowly than desired.

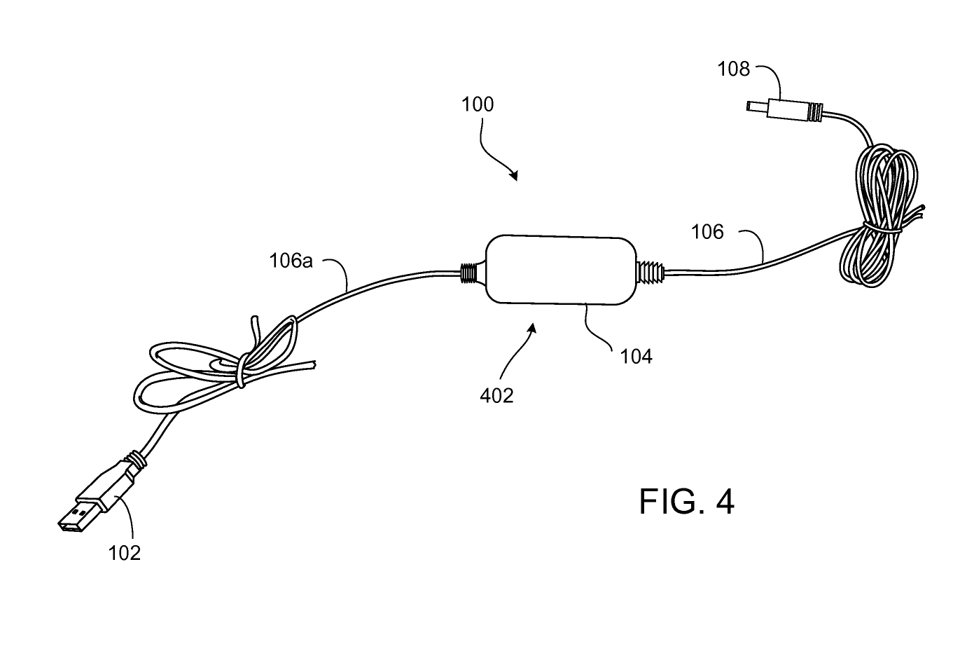

Implementations of device 100 can be used to recharge a rechargeable battery. For example, device 100 can include a conversion module 104 that converts power from an input voltage and current to an output voltage and current suitable to recharge the battery. An example conversion module 104 used to recharge a battery is shown in FIG. 3. In this example, conversion module 104 includes an input module 302, a charging module 304, a temperature protection module 306, and an interface module 308.

Input module 302 filters and/or regulates the electric input into conversion module 104 in order to protect convert module 104 from damage due to input power with undesirable characteristics. Input module 302 can be similar to input module 202, as described above.

Charging module 304 converts the filtered power from the input voltage and current to an output voltage and current, and delivers the converted power through the positive and negative battery pins, BAT+ and BAT−, respectively. Charging module 302 can be similar to boost module 204, as described above. For example, in some implementations, charging module 302 can step up an input voltage to a higher output voltage. Alternatively, in some implementations, charging module 302 can step down the voltage to a lower output voltage. Similar to boost module 204, charging module 204 need not output power that is equal to the input power. In an example, boost module 204 may convert input power having a voltage of 5V DC and a current of 1 A (5 W) to output power having a voltage of 4.2V DC and a current of 1 A (4.2 W).

Charging module 304 also can output power differently depending on the charge state of the battery. For example, if the battery is nearly depleted, charging module 304 can provide a relatively high amount of power to the battery, such that the battery is recharged more quickly. If the battery is approaching its energy capacity, charging module 304 can reduce the amount of power provided to the battery. If the battery has reached, or has nearly reached, its energy capacity, charging module 304 can stop or further reduce the amount of power provided to the battery, such that the battery is not overcharged. Charging module 304 can detect the charge state of the battery, for example, by determining the voltage of the battery along the positive and negative battery pins, BAT+and BAT−, respectively. In an example, charging module 304 detects the voltage of the battery and provides the highest amount of power when the detected voltage of the battery is between a predetermined range of low voltages, provides a lower amount of power when the detected voltage is between a predetermined range of medium voltages, and does not provide power when the detected voltage is above a predetermined threshold.

In some implementations, charging module 304 also can output power differently depending on the temperature of the battery. For example, if the battery is relatively cool, a temperature protection module 306 can instruct charging module 304 to provide a relatively high amount of power to the battery. If the battery is approaching a predetermined temperature limit, temperature protection module 306 can instruct charging module 304 may provide a reduced amount of power to the battery. If the battery has met or exceeded the temperature limit, temperature protection module 306 can instruct charging module 304 to cease the delivery of power to the battery. Temperature protection module 306 can detect the temperature of the battery, for example, by communicating with an appropriate thermal detection component of the battery (e.g., a negative temperature coefficient (NTC) or positive temperature coefficient (PTC) thermistor). Information regarding the temperature of the battery can be transmitted in a similar manner as the converted electrical power. For example, information can be transmitted through receptacle 144 of device 140, through output connection interface 108, and through cable 106 to conversion module 104.

Interface module 308 provides user feedback regarding the operational state of device 100. For instance, interface module 308 can provide information through a visual indicator, such as an LED or LCD display. In an example, interface module 308 can change the color or illumination pattern of an LED to indicate the charge state of the battery, the presence of input power into conversion module 104, or other status information regarding device 100.

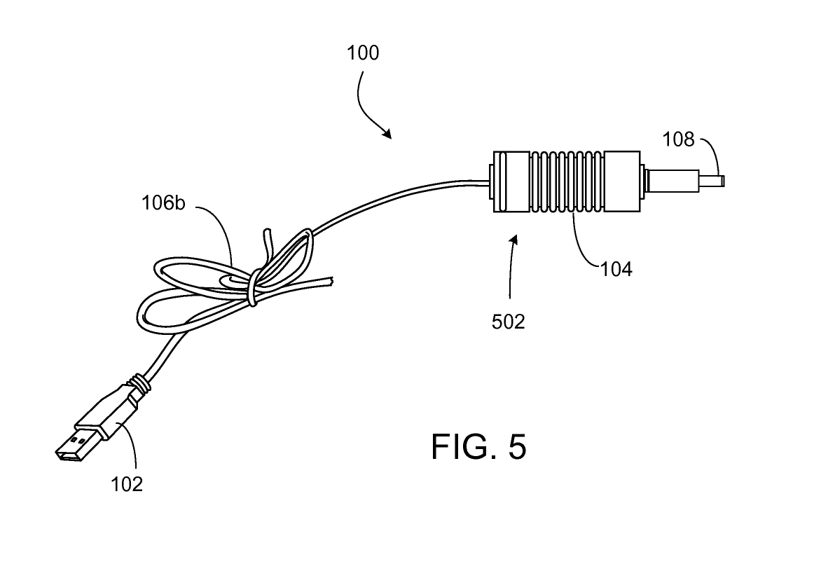

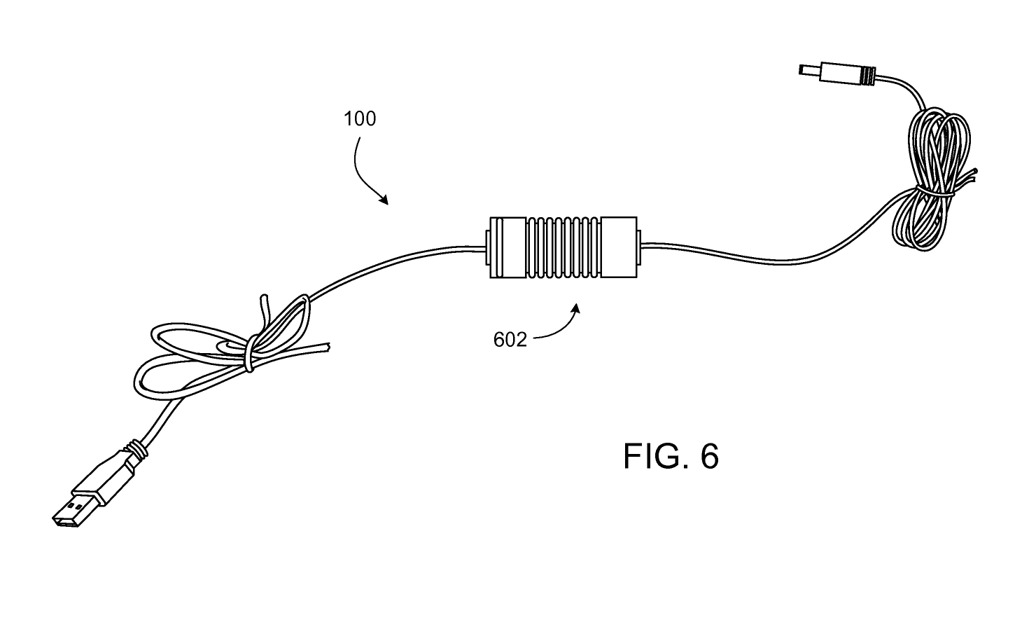

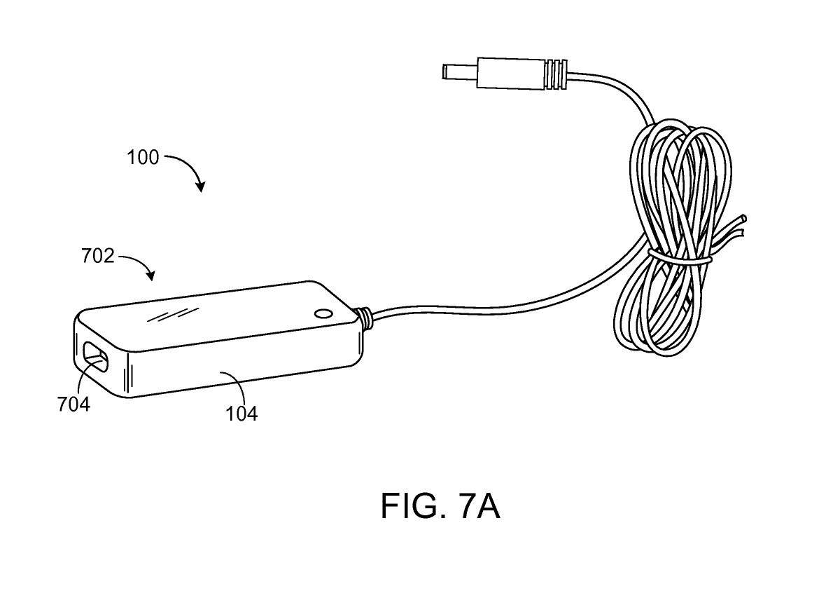

A number of embodiments have been described. Nevertheless, it will be understood that various modifications may be made without departing from the spirit and scope of the invention. For example, although FIG. 1 shows input interface connector 102 co-mounted to conversion module 104 within a housing 110, this need not be the case. As shown in FIG. 4, conversion module 104 can be positioned within a housing 402 that is distant from interface connector 102. Power can be carried from interface connector 102 to conversion module 104 through a second cable 106a of any desired length (e.g., 1 inch, 1 foot, 3 feet, or 6 feet). In another example, as shown in FIG. 5, conversion module 104 can be co-mounted to output interface connector 108 within a housing 502. In this example, only a single cable 106b is used to transfer power from input interface connector 102 to module 104. In some implementations, the shape and appearance of the housing can differ. For example, as shown in FIG. 6, housing 602 can differ in dimension (e.g., length, width, height, or radius) and shape compared to housing 402 of FIG. 4.

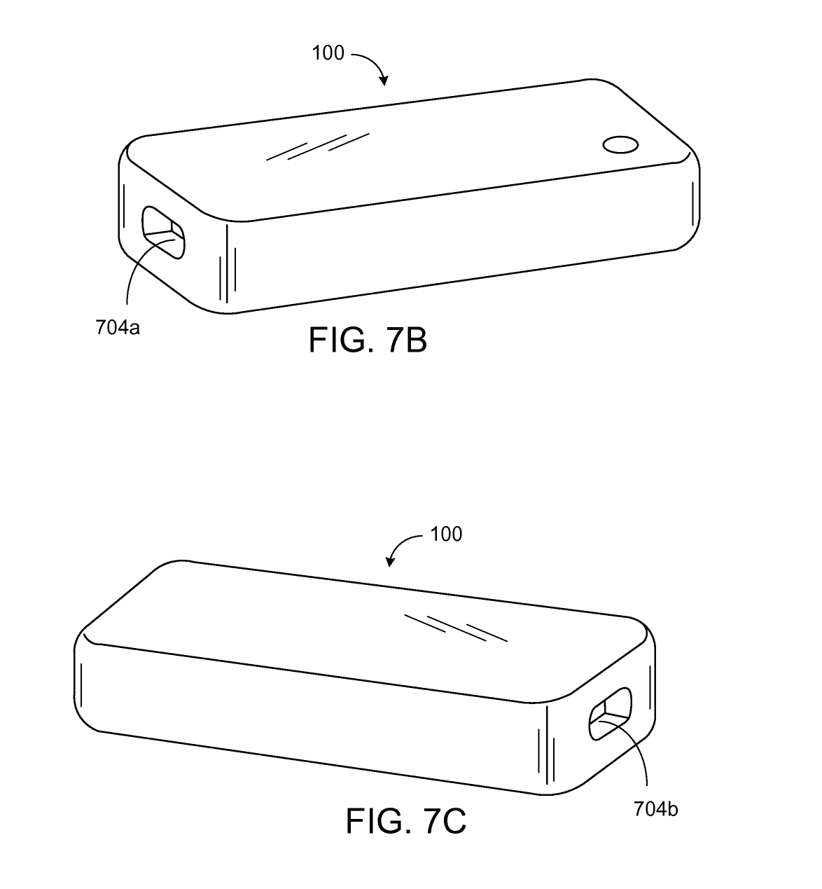

Each cable 106 of device 100 can be permanently attached to device 100 or detachably removable from device 100, depending on the implementation. In some implementations, one or more cables can be detachably removable from device 100. For example, as shown in FIG. 7A, a housing 702 (containing conversion module 104) can include a cable receptacle 704. An appropriate cable (not shown) can provide a connection between external power source 120 and device 100 by interfacing with cable receptacle 704. Cable receptacle 704 can be a standardized connector, or it can be a connector that is specific to a particular device or device manufacturer. Although FIG. 7A illustrates a detachable cable on the input side of device 100, device 100, either alternatively or alternatively, can have a detectable cable on the output side of device 100. For example, as shown in FIG. 7B-C, each of the input side (FIG. 7B) and the output side (FIG. 7C) of another example device 100 can have a corresponding cable receptacle 704a and 704b, respectively, in order to accept an appropriate detachable cable.

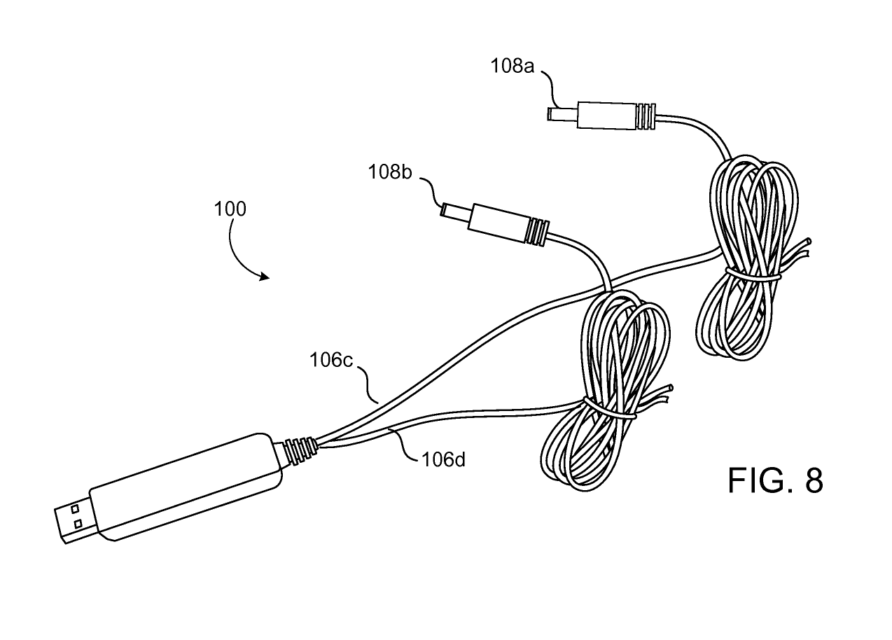

In some implementations, device 100 can have multiple cables on the input and/or output side of device 100. For example, as shown by FIG. 8, device 100 can have two cables 106c and 106d with output connection interface 108a and 108b, respectively. In this configuration, device 100 can power two devices from a single external power source. In some implementations, device 100 can have more than two cables 106 and corresponding output connection interfaces 108. For example, in some implementations, device 100 can have three, four, five, or more cables 106 and corresponding output connection interfaces 108. In some implementations, each output connection interface 108 can be similar or different. For example, device 100 can have multiple identical output connection interfaces 108, such that more than one of the same type of device can be powered simultaneously. In another example, device 100 can have two or more different output connection interfaces 108, such that different types of devices can be powered, either simultaneously or individually.

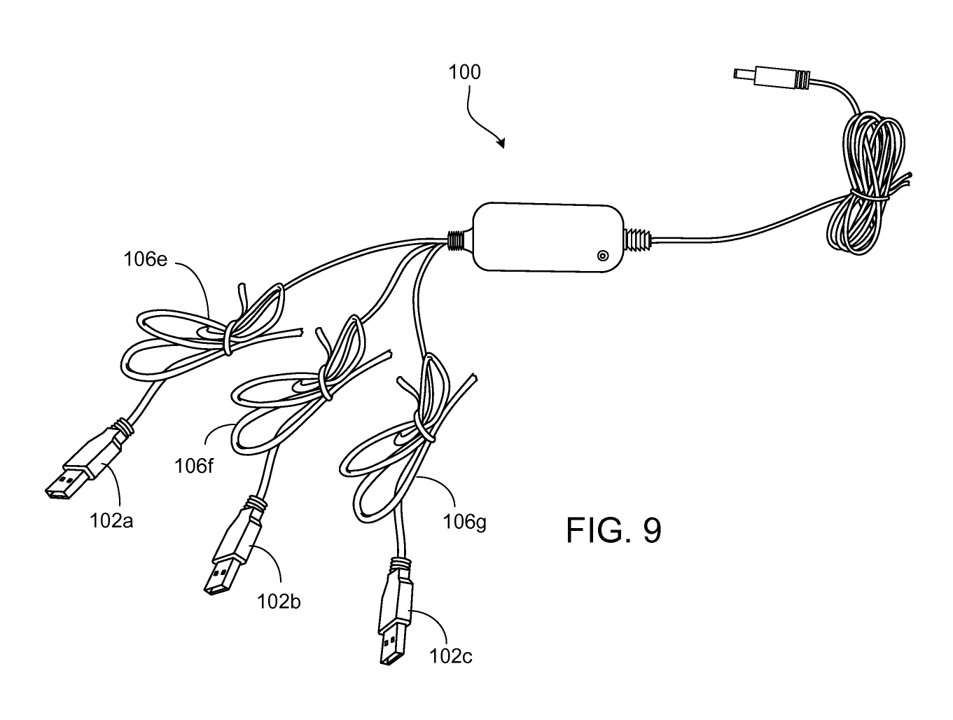

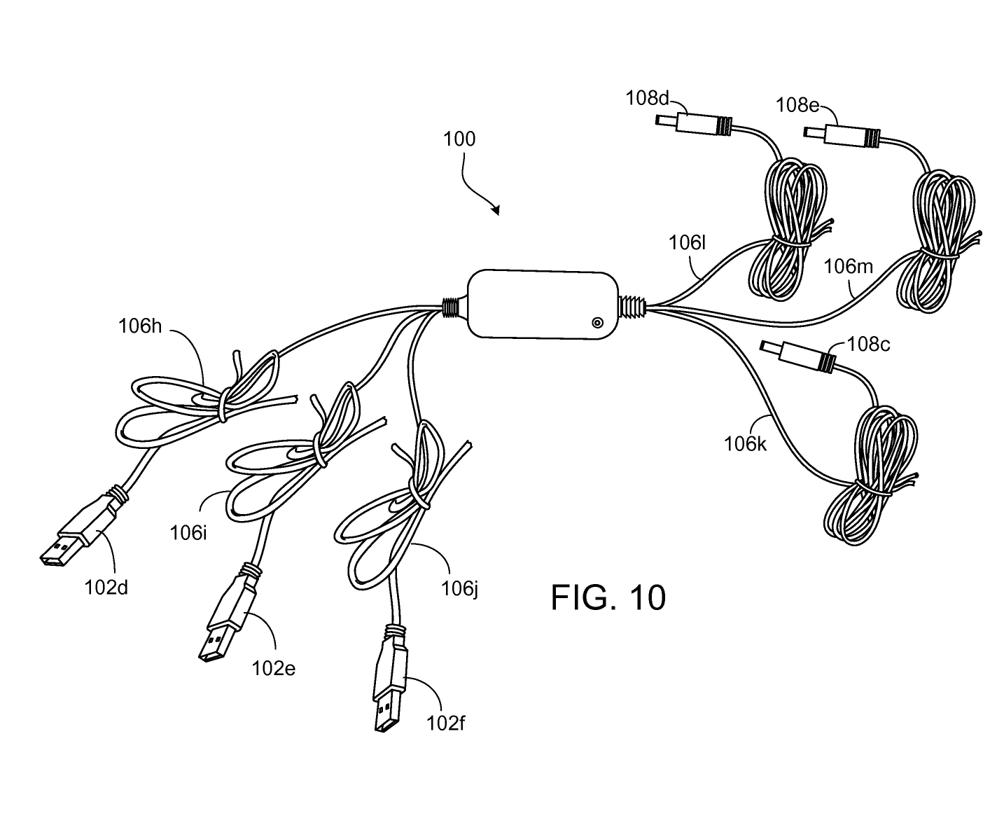

As shown in FIG. 9, in some implementations, device 100 can have three cables 106e-g with input connection interfaces 102a-c, respectively. In this configuration, device 100 can receive from power multiple external power sources and/or ports. For example, input connection interfaces 102a-c can be plugged into multiple external power sources to draw additional power from multiple sources, or plugged into multiple ports to draw more power than what can be drawn from a single port. This may be beneficial, for example in the case of USB, where current from a single port is limited to a specified value. In some implementations, device 100 can have fewer or more than three cables 106 (e.g., two cables) and corresponding input connection interfaces 102 on the input side For example, in some implementations, device 100 can have two, four, five, or more cables 106 and corresponding input connection interfaces 108. In some implementations, each input connection interface 102 can be similar or different. For example, device 100 can have multiple identical input connection interfaces 102, such that power can be drawn from more than one of the same type of device or port. In another example, device 100 can have two or more different input connection interfaces 102, such that power can be drawn from different types of devices or ports, either simultaneously or individually.

In some implementations, device 100 can have multiple cables on the input side of device 100, and multiple cables on the output side of device 100. In an example, as shown in FIG. 8, device 100 can have three cables 106h-j with input connection interfaces 102d-f, respectively, and three cables 106k-m with output connection interfaces 102d-f, respectively. As above, the number of cables and corresponding connection interfaces can be varied.

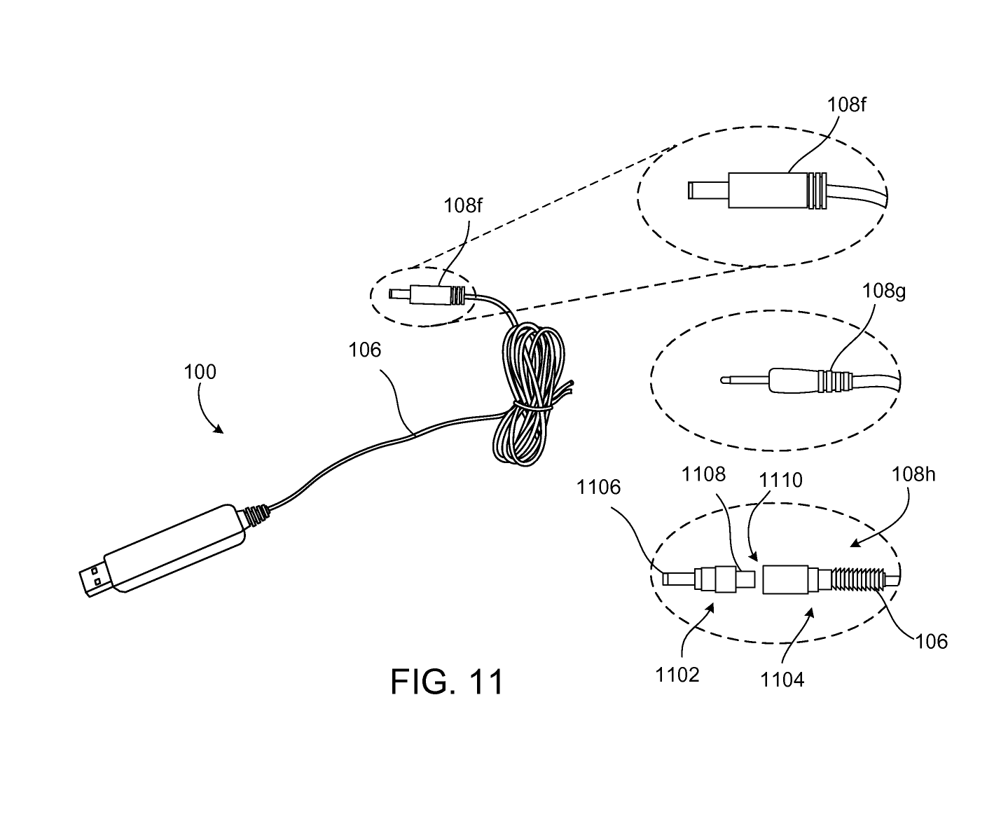

As discussed above, output connection interface 108 can be any connector suitable to interface with a receptacle 144. For instance, three different example output connection interfaces 108f-h are shown in FIG. 11, each adapted to couple a corresponding receptacle. In some implementations, output connection interface 108 can be detachable, such that different connection interfaces can be used. In an example, connection interface 108h includes a removable portion 1102 and a base portion 1104. Removable portion 1102 includes a plug 1106, which can be inserted into a corresponding receptacle on an external electronic device. Removable portion 1102 also includes a plug 1108, which can be inserted into a corresponding receptacle 1110 on base 1104. When plug 1106 is inserted into the receptacle of an external electronic device, and plug 1108 is inserted into receptacle 1110, power can be transferred from 106 to the external electronic device. Removable portion 1102 can be removed and replaced as desired in order to couple a different plug 1106 to device 100.

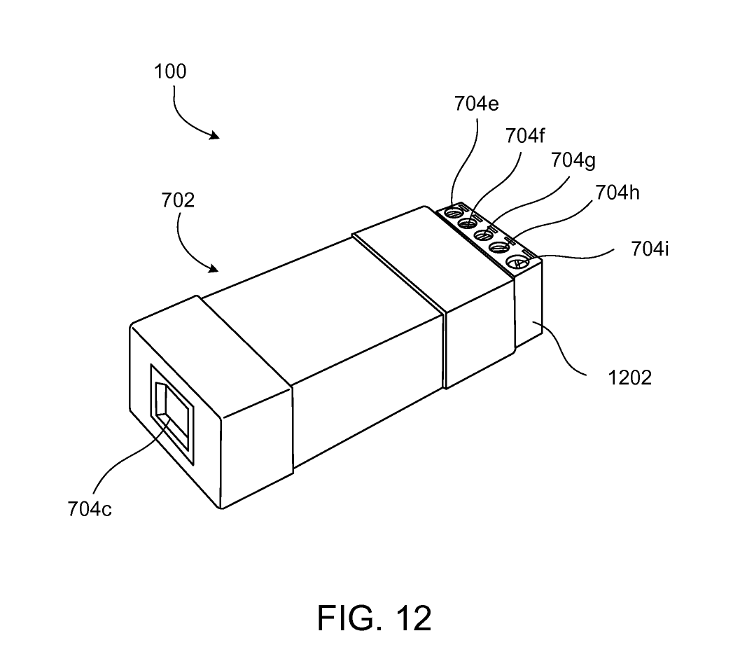

In some implementations, device 100 can output electrical power through a terminal block. For example, as shown in FIG. 12, an example device 100 includes a housing 702 containing conversion module 104, an USB Type B input cable receptacle 704c, and a terminal block 1202. Terminal block 1202 includes several output cable receptacles 704e-i, to which one or more conductors from a cable or wire can be secured (e.g., by securing an un-insulated tip of the cable or wire to the receptacle 704e-i through a screw, clip, or other securing component). Each output cable receptacle 704e-i can output power independently of the other output cable receptacles, or two or more receptacles can carry power in conjunction. For example, in some implementations, one output cable receptacle can act as a positive terminal and another can act as a negative terminal during power transmission to a connected device. Although FIG. 12 shows five output cable receptacles, device 100 can have fewer or more than five output cable receptacles, depending on the implementation.

As discussed above, implementations of device 100 can be used to convert input DC power into output DC power of a different voltage. However, device 100 need not be limited to performing DC to DC power conversion. For example, in some implementations, device 100 can convert DC power to alternating current (AC) power. The outputted AC power can have the same voltage or a different voltage compared to that of the input power, which, depending on the implementation, may be higher or lower than the voltage of external power source. For example, in some implementations, the device converts input power of 5V DC to output power of 120V AC. In another example, in some implementations, the device converts input power of 5V DC to output power of 5V AC. The outputted AC power can also vary in frequency. For example, in some implementations, the device outputs AC power at 50 Hz or 60 Hz.

Accordingly, other implementations are within the scope of the claims.

What is claimed is:

1. An apparatus for providing electrical power to an electronic device comprising:
an input interface comprising a Universal Serial Bus (USB) connector;
an output interface comprising an output connector; and
a conversion module;
wherein the input interface is arranged to:
couple to an external power source through the USB connector; and
transmit electrical power at a first voltage from the external power source to the conversion module;
wherein the conversion module is arranged to:
convert electrical power at the first voltage into electric power at a second voltage; and
wherein the output interface is arranged to:
couple to the electronic device through the output connector; and
transmit electrical power at the second voltage from the conversion module to the electronic device.

2. The apparatus of claim 1, wherein the electrical power at the first voltage and the electrical power at the second voltage are direct current (DC)-based.

3. The apparatus of claim 1 wherein the electronic device further comprises a battery, and wherein the conversion module comprises a regulation module to regulate the transmission of electrical power to the electronic device based on a charge state of the battery.

4. The apparatus of claim 3 wherein electrical power is transmitted to the electronic device at a first rate when the battery is in an uncharged or partially charged state.

5. The apparatus of claim 4 wherein electrical power is transmitted to the electronic device at a second rate when the battery is in a substantially fully charged state, wherein the second rate is less than the first rate.

6. The apparatus of claim 1 wherein the USB connector comprises a male USB plug.

7. The apparatus of claim 1 wherein the input interface further comprises an electrically conductive cable that couples the USB connector to the conversion module.

8. The apparatus of claim 7 wherein the cable is coupled to the conversion module through a detachable interface.

9. The apparatus of claim 1 wherein the first voltage is 5 V.

10. The apparatus of claim 1 wherein the first voltage is less than the second voltage.

11. The apparatus of claim 1 wherein the first voltage is greater than the second voltage.

12. The apparatus of claim 1 wherein the electronic device comprises at least one member from a group consisting of: a computing device, a telephone, an electronic testing device, a battery charger, and a battery.

13. The apparatus of claim 1, wherein the electrical power at the first voltage is direct current (DC)-based, and the electrical power at the second voltage is alternating current (AC)-based.

14. A system comprising:
an electronic device;
an external power source; and
a Universal Serial Bus (USB)-based cable comprising:
an input interface comprising a USB connector coupled to the external power source through the USB connector;
an output interface comprising an output connector; and
a conversion module;
the input interface being arranged to transmit electrical power at a first voltage from the external power source to the conversion module;
the conversion module being arranged to convert electrical power at the first voltage into electric power at a second voltage; and
the output interface being arranged to couple to the electronic device through the output connector and transmit electrical power at the second voltage from the conversion module to the electronic device.

15. The system of claim 14 wherein the electrical power at the first voltage and the electrical power at the second voltage are direct current (DC)-based.

16. The system of claim 14 wherein the electronic device further comprises a battery, and wherein the conversion module comprises a regulation module to regulate the transmission of electrical power to the electronic device based on a charge state of the battery.

17. The system of claim 16 wherein electrical power is transmitted to the electronic device at a first rate when the battery is in an uncharged or partially charged state.

18. The system of claim 17 wherein electrical power is transmitted to the electronic device at a second rate when the battery is in a substantially fully charged state, wherein the second rate is less than the first rate.

19. The system of claim 14 wherein the USB connector comprises a male USB plug.

20. The system of claim 14 wherein the input interface further comprises an electrically conductive cable that couples the USB connector to the conversion module.

21. The system of claim 20 wherein the cable is coupled to the conversion module through a detachable interface.

22. The system of claim 14 wherein the first voltage is 5 V.

23. The system of claim 14 wherein the first voltage is less than the second voltage.

24. The system of claim 14 wherein the first voltage is greater than the second voltage.

25. The system of claim 14 wherein the electronic device comprises at least one member from a group consisting of: a computing device, a telephone, an electronic testing device, a battery charger, and a battery.

26. The system of claim 14, wherein the electrical power at the first voltage is direct current (DC)-based, and the electrical power at the second voltage is alternating current (AC)-based.
